(19) United States
(12) Patent Application Publication
(10) Pub. No.: US 2009/0178449 A1
(43) Pub. Date: Jul. 16, 2009

(54) LOCK BODY

(75) Inventor: Juha Raatikainen, Joensuu (FI)

Correspondence Address: SMITH-HILL AND BEDELL, P.C., 16100 NW CORNELL ROAD, SUITE 220, BEAVERTON, OR, 97006, US

(73) Assignee: ABLOY OY, Joensuu (FI)

(21) Appl. No.: 12/299,104

(22) PCT Filed: Apr. 23, 2007
(86) PCT No.: PCT/FI2007/050215

§ 371 Date: Oct. 30, 2008

(30) Foreign Application Priority Data
May 2, 2006 (FI) 20065281

(51) Int. Cl. E05B 53/00; E05B 47/02; E05B 49/00; F16H 1/20

(52) U.S. Cl. 70/263; 70/277; 70/278.7; 74/425

(57) ABSTRACT

A lock body includes a bolt and a follower that is functionally connectable with the bolt to control the position of the bolt, and a driver. The driver is connectable with the follower to convey force turning the driver to the follower. Furthermore, the lock body includes an electric motor to operate as a power source for changing the locking state of the lock body.

### FIELD OF TECHNOLOGY

The present invention relates to lock bodies equipped with an electric motor. In particular, the invention relates to a motor lock body for installation in an emergency exit door or fire door.

### PRIOR ART

It is known that an electric motor is used in lock bodies to unlock and lock the lock body—that is, to change a locking state of the lock body. Lock bodies equipped with an electric motor are often referred to as motor locks. The electric motor can be controlled, for example, by a push button installed in connection with the lock, an access control reader beside the lock, or a central unit for the building's locking. A motor lock can also be fitted with a key cylinder, allowing the locking state of the lock body to be mechanically unlocked/locked using a key. There may also be a handle installed in connection with the lock that can be turned and is linked to the rest of the lock body mechanism only when the lock is opened using the electric motor. Thus a motor lock is suitable for use in connection with door automation and electric control.

It is known that an emergency exit knob is used in connection with a lock installed in an emergency exit door or fire door. A common type of emergency exit knob is a turning grip protected with a breakable dome. After breaking the dome, the lock can be unlocked by turning the knob. Breaking the dome normally triggers an alarm to be sent to an alarm centre. Thus, in case of power outage, the lock can be opened using the emergency exit knob, not using the normal lock handle if one exists. Motor locks fitted with a knob are suitable for applications including those in which the door is open/can be opened normally during opening hours and is closed at other times (evenings, nights, weekends), or in which there is an access control device in connection with the door. A normal motor lock installation configuration equipped with an emergency exit knob has a handle for normal use and a knob for emergency situations. The problem is that emergency exit knob domes are broken maliciously, which also triggers false alarms. Furthermore, some types of dome leave at least part of the emergency exit knob exposed, and users may accidentally use the knob in normal circumstances.

### SHORT DESCRIPTION OF INVENTION

The objective of the invention is to eliminate the problems of technology described above. The objective is achieved through a solution according to claim 1. The dependent claims describe embodiments of the invention in more detail.

A lock body 1 according to the invention comprises a bolt 3 and a follower 6 that is functionally connectable with the bolt 3 to control the position of the bolt, and a driver 5. The driver is connectable to the follower to convey force turning the driver to the follower. Furthermore, the lock body comprises an electric motor 9 to operate as a power source for changing a locking state of the lock body. The follower 6 has a force transmission surface 19B.

The lock body also comprises a turnable latch plate 8 with a first mating surface 19A and a second mating surface 18A, as well as a force transmission/control means 11, 12 that is functionally connected with the electric motor 9 and is functionally connectable with the latch plate 8. The first mating surface 19A of the latch plate 8 is arrangable to contact against the force transmission surface 19B, which makes it possible to control the position of the follower 6 with the electric motor through the force transmission/control means 11, 12. The second mating surface 18A is arrangable to a linking position against the driver 5, making it possible to control the position of the follower with force turning the driver.

The bolt 3 of the lock body can be driven to the outer or inner position with the electric motor. Furthermore, the bolt can be driven to the outer or inner position using the driver when the latch plate 8 has been driven to the linking position using the electric motor—that is, to the driver control position in which it enables a force transmission link between the driver and the follower. Under electric motor control, the lock body is suitable for normal use. Under driver control, the lock body is suitable for emergency exit use in which the door can be opened using a handle in the lock body.

A separate emergency exit knob is not required. Access control can be in operation both in normal use and in emergency exit use.

For the sake of power outages, it is preferred that the lock body according to the invention is equipped with a backup power source 62. In this case, the lock body 1 comprises a driving unit 64 and a backup power source 62 for the electric motor 9 to drive the second mating surface 18A to the linking position against the driver 5 when the normal power source for the electric motor is unavailable.

### LIST OF FIGURES

In the following, the invention is described in more detail by reference to the enclosed drawings, where

FIG. 1 illustrates an example of a lock body according to the invention, with the bolt out and the follower under motor control,

FIG. 2 illustrates an example of the lock body of FIG. 1, with the bolt in and the follower under motor control,

FIG. 3 illustrates an example of the lock body of FIG. 1, with the bolt out and the follower under driver control,

FIG. 4 illustrates an example of the lock body of FIG. 1, with the bolt in and the follower under driver control,

FIG. 5 illustrates an example of the lock body of FIG. 1, with the bolt in and the follower under continuous driver control, and

FIG. 6 illustrates an example of a backup power source internal to the lock body.

### DESCRIPTION OF THE INVENTION

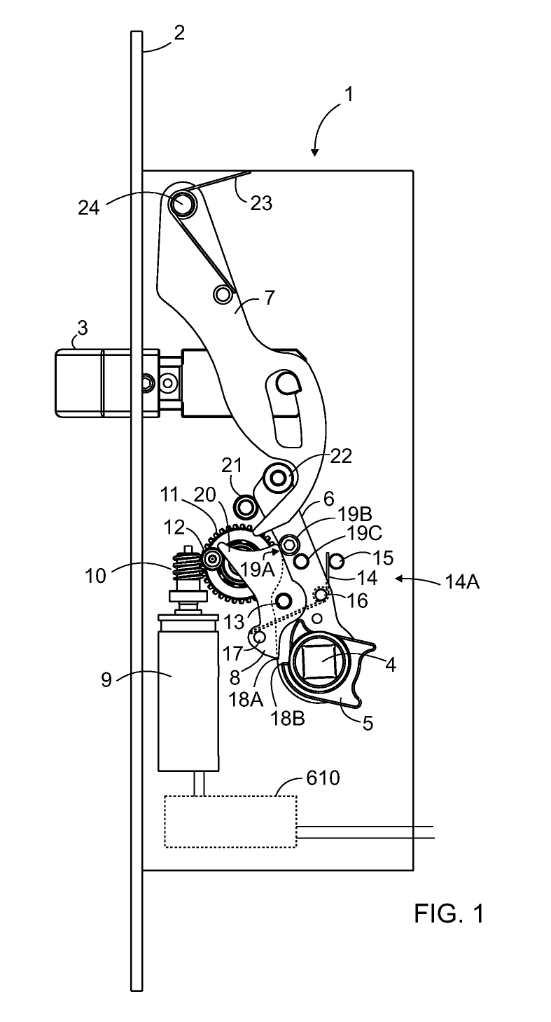

FIG. 1 illustrates an example of a lock body 1 according to the invention. The bolt 3 is out—that is, the end of the bolt forms a barring projection in relation to the front plate 2 of the lock body.

The extrusion length of the bolt in relation to the front plate can be 14 or 20 mm, for example. The follower 6 is under motor control in the state illustrated in FIG. 1.

In addition to the bolt, the lock body 1 comprises a follower 6 that is functionally connectable with the bolt 3 to control the position of the bolt, and a driver 5. The driver is connectable with the follower to convey force turning the driver to the follower. It is also possible that there are separate drivers on both sides of the follower, one of which has a solid transmission link to the follower while the other has a connectable force transmission link to the follower. In this case, a divided spindle is used in place of a uniform spindle.

In a normal installation configuration, the driver is connected to the spindle, which is further connected to a handle or other turnable element. Thus, turning the handle will cause the driver to turn, and the follower will also turn if it is linked to have a force transmission connection with the driver. The spindle is connected to the centre opening 4 of the driver.

Furthermore, the lock body comprises an electric motor 9 to operate as a power source for changing a locking state of the lock body. The follower 6 also has a force transmission surface 19B, 19C.

The lock body also comprises a turnable latch plate 8 with a first mating surface 19A and a second mating surface 18A, as well as a force transmission/control means 11, 12 that is functionally linked to the electric motor 9 and is functionally connectable with the latch plate 8.

The first mating surface 19A of the latch plate 8 can be arranged to contact against the mating surface 19B, 19C, which makes it possible to control the position of the follower 6 with the electric motor through the force transmission/control means 11, 12. The second mating surface 18A can be arranged to a linking position against the driver 5, making it possible to control the position of the follower with force turning the driver.

The functional linking of the follower 6 to the bolt 3 is carried out using a force transmission lever 7, for example. In this case, the follower has a surface 22 through which the follower can be linked to have a force transmission connection with the force transmission lever. In FIG. 1, the force transmission lever 7 is arranged to turn in relation to a pivot shaft 24. A spring 23 is usually arranged in connection with the pivot shaft.

The functional connection between the latch plate and the electric motor 9 is arranged in FIG. 1 through a control surface 20 in the latch plate. The control surface can be arranged to contact against the force transmission/control means 11, 12, which in turn is functionally connectable with the electric motor.

In the example illustrated in the figure, the force transmission/control means comprises a gearwheel 11 to which a contact wheel 12 is linked to form contact against the control surface 20 of the latch plate. In the example, the outer edge of the gearwheel 11 is cogged. The electric motor 9 in the example of FIG. 1 comprises a worm screw 10, the threads of said screw being arranged against the cogging of the gearwheel 11.

A latch plate 8 according to the example comprises a hinge arrangement 13 that forms the pivot shaft of the latch plate. The hinge arrangement can be a pin on the latch plate that can be fitted into a hole in the lock body 1 or the follower 6, or vice versa, in which case the hole is in the latch plate and the pin is in the lock body or follower. Even though the latch plate 8 can be hinged directly on the lock body, it is preferred that the latch plate is hinged in a pivoting manner on the follower as illustrated in FIGS. 1-5.

It is preferred that the turning of the latch plate in relation to the pivot shaft of the latch plate is arranged to be reliable. One method of arranging reliability is that the lock body comprises a spring arrangement 14A to turn the control surface 20 of the latch plate towards the force transmission/control means 11, 12. It is also preferred that the spring arrangement 14A is also arranged to turn the second mating surface 18A of the latch plate towards the driver 5. When the latch plate is hinged on the follower, it is preferred that the same spring arrangement 14A is also arranged to turn the follower 6 towards the front plate 2 of the lock body as illustrated in FIGS. 1-5. It can be seen from FIG. 1 that a support surface 21 is attached to the lock body, and the follower rests against this. The use of a support surface reduces the load imposed on the force transmission means 11, 12 by the spring arrangement.

In the example of FIGS. 1-5, the spring arrangement 14A comprises a first support point 15 attached to the lock body, a second support point 16 attached to the follower, a third support point 17 attached to the latch plate, and a spring 14 supported by said support points. The spring arrangement can be naturally arranged otherwise. The first support point 15 can be attached to the follower, for example, in which case the spring arrangement does not turn the follower. In this case, another spring arrangement is required to ensure that the follower turns. In FIGS. 1-5, the shapes of the spring 14 and the follower 6 covered by other parts are presented with dashed lines.

The latch plate can be shaped in many different ways. In the example illustrated in the figures, the latch plate 8 comprises a first cam part having said control surface 20, and a second cam part having said second mating surface 18A. The first mating surface 19A, the second mating surface 18A and the control surface 20 are located in different sectors in relation to the pivot shaft of the latch plate 8. If the latch plate is hinged directly on the lock body, the shapes of the plate are different.

In the example illustrated in the figures, the force transmission surface of the follower referred to in the above is the surface 19B of the end of a screw connected to the follower or the surface 19C of a projection in the follower. The projection can be a pin, for example. In other words, the force transmission surface has been arranged as selectable between two alternatives. The selection depends on whether an extrusion of 20 mm or 14 mm is used for the bolt. When a screw forms the force transmission surface 19B, the extrusion is 20 mm. When a projection forms the force transmission surface 19C, the extrusion is 14 mm. Thus, in FIGS. 1-5, the bolt extrudes 20 mm from the front plate 2.

If the lock body is only intended for a bolt of a certain length, the force transmission surface can be arranged solely by a projection in the follower, a screw or another suitable surface in the follower. The arrangement of a suitable surface also depends on an implementation of the latch plate.

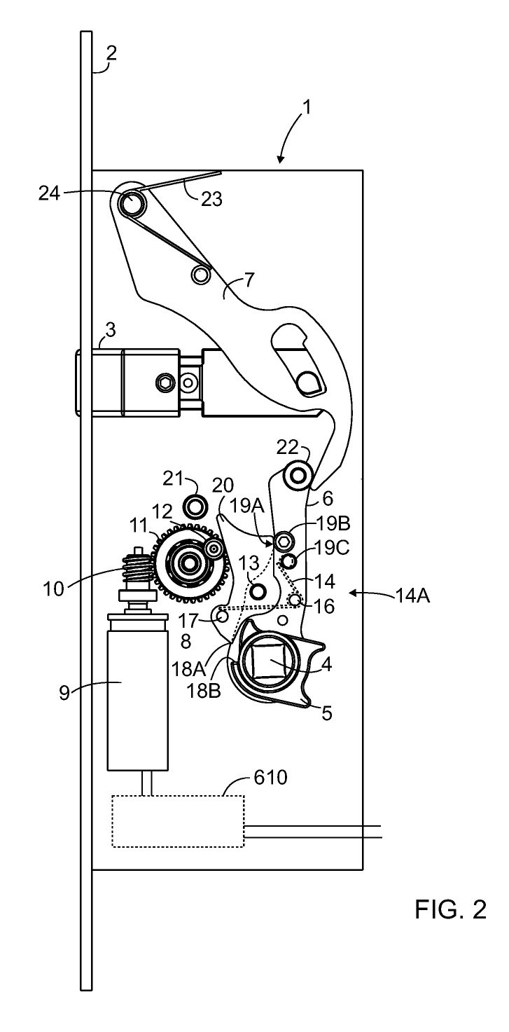

In FIG. 1, the follower 6 controlling the bolt is under electric motor control through the force transmission means 11, 12 and the latch plate 8. When the electric motor is driven so that the bolt 3 is pulled inside the lock body using the follower 6, the result is the state illustrated in FIG. 2. The electric motor has turned the gearwheel 11 so that the contact wheel 12 has moved towards the follower and simultaneously pushed the latch plate, which in turn has pushed the follower to turn towards the back section of the lock body. The follower turned towards the back section has turned the transmission plate 7, which in turn has pulled the bolt 3 inside the lock body.

It can be seen from FIGS. 1 and 2 that suitable shaping of the follower can be used to achieve delayless transmission of force from the electric motor to the follower. Delayless operation will be achieved when the control surface of the latch plate is against the force transmission/control means 11, 12 and the first mating surface 19A is against the force transmission surface 19B of the follower while the bolt is out under motor control.

It can thus be stated that when the bolt 3 is out, the control surface 20 of the latch plate is arranged to be against the force transmission/control means 11, 12 in the position of the latch plate 8 determined by the control of the electric motor 9. Furthermore, the force transmission surface 19B of the follower can be arranged against the first mating surface 19A of the latch plate 8 when the latch plate is against the force transmission/control means 11, 12.

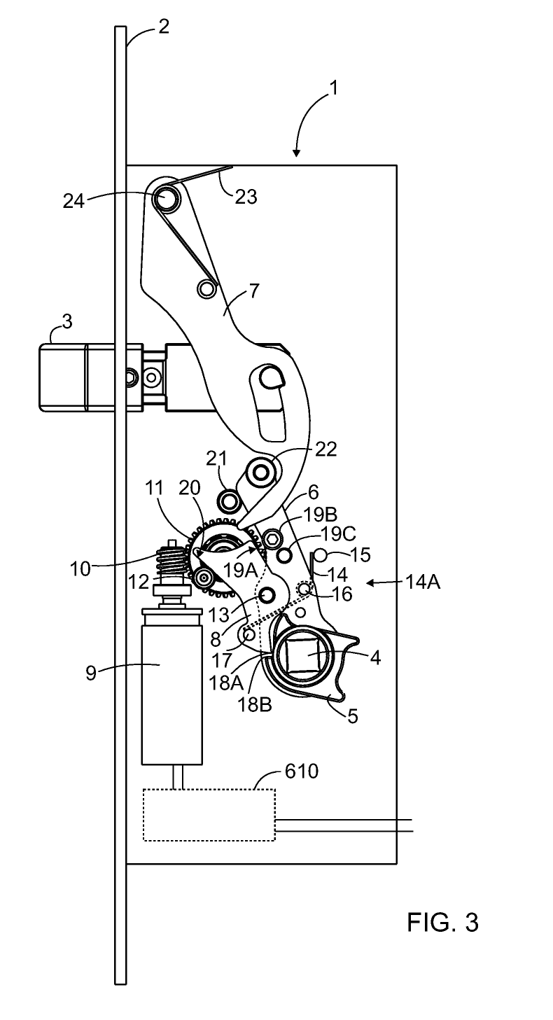

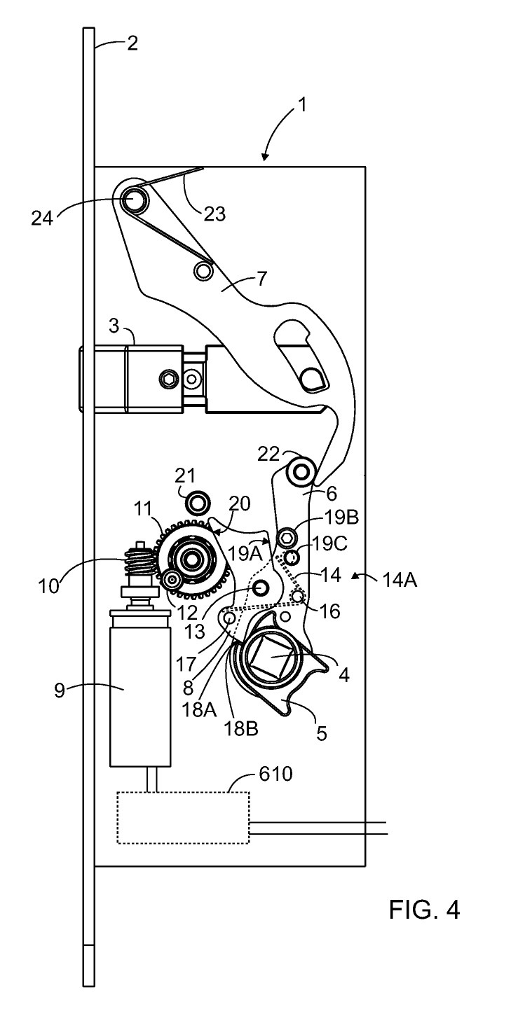

In FIG. 3, the electric motor has been driven so that the bolt 3 is out and the follower is under driver control. The electric motor has turned the gearwheel 11 so that the contact wheel 12 has moved in an opposite direction compared to FIGS. 1 and 2, simultaneously allowing the latch plate to turn in relation to its pivot shaft. The turning of the latch plate is ensured using a spring arrangement. The second mating surface 18A of the turned latch plate is in the linking position against the driver's control surface 18B. When a handle connected to the driver (or another turnable element connected to the spindle) is turned, the driver's mating surface 18B forms a force transmission connection to the second mating surface 18A of the latch plate. In this case, the handle also turns the latch plate and the follower linked to the latch plate. In FIGS. 3 and 4, the latch plate is connectable with the follower through the hinge arrangement 13, and in FIG. 4, the bolt is pulled in under driver control. By using another type of hinge arrangement, the connection between the latch plate and the follower under driver control can also be achieved otherwise. For example, said force transmission surface 19B, 19C of the follower can be used in order to create a connection.

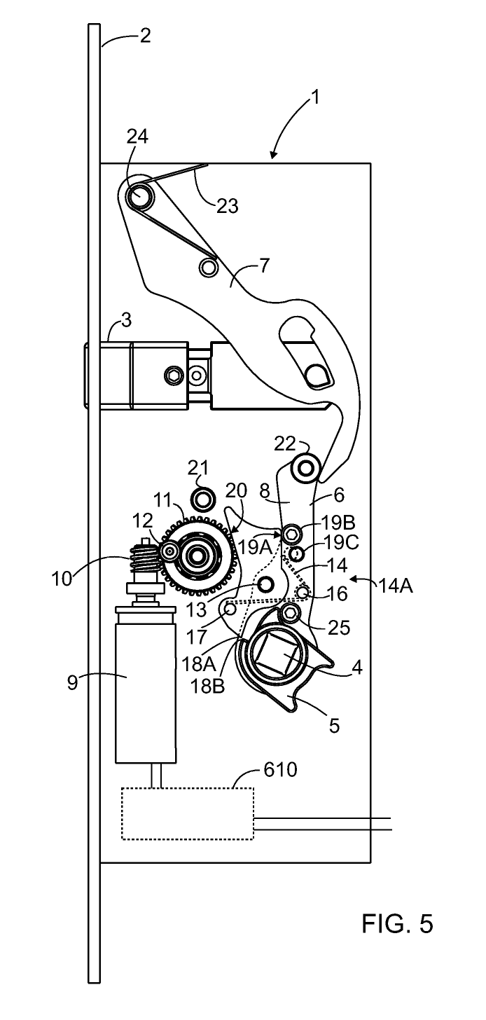

In FIG. 5, the follower is under continuous driver control. Continuous driver control is achieved through screw 25 that is attached to the follower 6. The driver 5 has a projection that settles against the screw 25 when the driver is turned. In FIG. 5, the bolt is pulled in under continuous driver control.

Electric motor locks have an electric motor drive/power supply unit 610. The task of the drive/power supply unit is to control the driving of the electric motor. The power source is an electric grid external to the lock body. In order to be able to unlock the lock body in emergency exit operation during a power outage, the lock body must be under driver control. However, it is possible that normal power supply to the lock is interrupted while the lock is under motor control. There must be a backup power source for this situation. It is preferred that the backup power source be located inside the lock body.

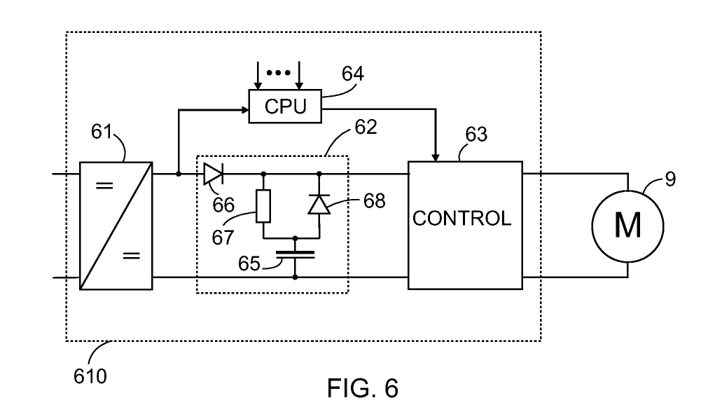

FIG. 6 illustrates an example arrangement for a backup power source located inside the lock body. FIG. 6 is simultaneously a more detailed illustration of the drive/power supply unit 610. The arrangement comprises a driving unit 64 and a backup power source 62 for the electric motor 9 to drive the second mating surface 18A of the latch plate to the linking position against the driver 5 when the normal power source for the electric motor is not available. In this case, the locking state of the lock body can be controlled using the driver 5.

The arrangement normally has a DC transformer 61 to transform an external electric voltage to be suitable to operate the lock body. A control unit 63 carries out the electric current switching operations in relation to the motor 9. The driving unit 64, in turn, drives the control unit 63 in response to external signals (sensor, push button, central control and other such signals). Thus the driving unit 64 comprises connections to the outside of the lock body to control the electric motor 9.

The backup power source 62 preferably comprises a capacitor 65 that can be charged using the normal power source during normal operation and that can be discharged under the control of the driving unit 64 when the normal power source is unavailable. In the example of FIG. 6, the DC transformer serves as the power source for the control unit 63 during normal operation. During normal operation, the DC transformer also serves as the source of charging current for the capacitor 65. The charging current flows through a first diode 66 and a resistor 67 to the capacitor. The driving unit 64 monitors whether the DC transformer operates as the normal power source. During a power outage, the DC transformer no longer operates as a power source, and the driving unit detects this. It this case, the driving unit drives the control unit so that the electric energy charged into the capacitor discharges through the second diode 68 and the control unit to the electric motor, switching lock control to driver control. The energy of the capacitor must not become discharged before the lock is switched to driver control. The capacitor is preferably a so-called super capacitor.

In a lock body according to the invention, the bolt is either in the inner position—that is, inside the lock body—or in the outer position, forming a barring projection. The bolt is arranged to be deadbolted while in the outer position—that is, the bolt will not move into the lock body by pressing the bolt. Thus the lock body is deadbolted when the bolt is out and the door is against the frame of the doorway. During a power outage, the lock body is switched to driver control and the lock can be unlocked using the handle. When the door is closed, the bolt does not return directly to the deadbolted position, as this would not allow the door to become barred against the edge of the doorway. The use of an auxiliary bolt allows the barring main bolt to move to the deadbolted position when the door is against the frame of the doorway. Such use of an auxiliary bolt is known so it is not described in more detail in the text and figures. Thus the lock fulfils the regulation set for fire doors, according to which the door must become barred against the frame of the doorway when closing.

A lock body according to the invention does not require a separate emergency exit knob and dome; the lock body can be unlocked using the normal handle also in emergency situations. This will eliminate vandalism to the dome and false alarms.

The lock body is also suitable for use with door automation (automatic opening and closing of the door). A door equipped with a lock body according to the invention operates normally in connection with door automation and simultaneously serves as a fire door. The lock body is also suitable for use in connection with access control. In addition to normal operation, access control can also be active in emergency situations, allowing free exit through a door equipped with a lock body according to the invention but blocking entry without a valid access right.

With regard to normal operation, the lock body according to the invention also offers user comfort. While the bolt of the lock body can be driven fully in with the electric motor in normal operation, there is no need to turn the handle. Thus, after electric motor control (e.g. access control system, push button control), the door can be opened by simple pushing or pulling.

In addition to the embodiments referred to in the above, a lock body according to the invention can also be implemented by other means. It is thus clear that any inventive embodiment can be implemented within the scope of the inventive idea.

1-18. (canceled)

19. A lock body comprising:
a bolt,
a follower that is functionally connectable with the bolt to control the position of the bolt, the follower having a force transmission surface,
a driver that is connectable with the follower to convey force turning the driver to the follower,
an electric motor to serve as a power source for changing a locking state of the lock body,
a turnable latch plate having a first mating surface and a second mating surface and being selectively turnable to a first position in which the first mating surface contacts the force transmission surface of the follower or to a second position in which the second mating surface is in a linking position against the driver, and
a force transmission/control means that is functionally connected with the electric motor and is functionally connectable with the latch plate for turning the latch plate to its first position or second position,
whereby in the first position of the latch plate the position of the follower is controllable with the electric motor through the force transmission/control means, and in the second position of the latch plate the position of the follower is controllable with force turning the driver.

20. A lock body according to claim 19, comprising conductors for supplying operating power to the electric motor from a main source of operating power, and a backup power source for the electric motor for driving the electric motor to turn the latch plate to the second position when the conductors do not supply operating power to the electric motor from the main source.

21. A lock body according to claim 20, wherein the backup power source comprises a capacitor that is charged using the main source of operating power during normal operation and discharges under control of a driving unit when the conductors do not supply operating power from the main source.

22. A lock body according to claim 21, wherein the driving unit has connections to the outside of the lock body for controlling the electric motor.

23. A lock body according to claim 19, wherein the latch plate is mounted for turning about a pivot shaft.

24. A lock body according to claim 19, wherein the latch plate has a control surface and the force transmission/control means is operable to turn the latch plate to its first or second position by engaging the control surface.

25. A lock body according to claim 24, wherein the latch plate is mounted to the follower and is turnable relative thereto.

26. A lock body according to claim 24, comprising a spring mechanism for urging the latch plate to turn towards a position in which the control surface of the latch plate engages the force transmission/control means.

27. A lock body according to claim 26, wherein the spring mechanism uses the latch plate to turn towards said second position.

28. A lock body according to claim 26, wherein the lock body has a front plate and the spring mechanism urges the follower to turn towards the front plate.

29. A lock body according to claim 26, wherein the spring mechanism engages a first support element attached to the lock body, a second support element attached to the follower, and a third support element attached to the latch plate.

30. A lock body according to claim 24, wherein the bolt is movable relative to the lock body to a projecting position and in the projecting position the latch plate is positioned such that the force transmission/control means can be moved by the electric motor to a position in which the force transmission/control means engages the control surface.

31. A lock body according to claim 24, wherein the force transmission/control means is operable to turn the latch plate to the first position when the force transmission/control means engages the control surfact of the latch plate.

32. A lock body according to claim 24, wherein the control surface of the latch plate and the second mating surface of the latch plate form first and second cam surfaces respectively.

33. A lock body according to claim 24, wherein the latch plate is mounted for turning about a pivot shaft and the first mating surface, the second mating surface and the control surface are located in different sectors relative to the pivot shaft.

34. A lock body according to claim 19, wherein the force transmission/control means comprises a gear wheel and a contact wheel attached to the gear wheel for engages the control surface of the latch plate.

35. A lock body according to claim 34, wherein the gear wheel has an outer edge that is cogged and the electric motor comprises a worm screw having a thread engaging the cogging of the gear wheel.

36. A lock body according to claim 19, wherein the force transmission surface of the follower is a surface of a screw engaging the follower or a surface of a projection projecting from the follower.

37. A lock body according to claim 19, comprising a screw engaging the follower and against which the driver is turnable.
